(19) United States
(12) Patent Application Publication
(10) Pub. No.: US 2013/0230363 A1
(43) Pub. Date: Sep. 5, 2013

(54) SCREW WITH MULTI-HEXAHEDRON HEAD

(71) Applicant: Ling-Hong ZENG, Shenzhen City (CN)

(72) Inventor: Ling-Hong ZENG, Shenzhen City (CN)

(73) Assignees: HON HAI PRECISION INDUSTRY CO., LTD., Tu-Cheng (TW); Fu Tai Hua Industry (Shenzhen) Co., Ltd.,, ShenZhen City (CN)

(21) Appl. No.: 13/459,103

(22) Filed: Apr. 28, 2012

(30) Foreign Application Priority Data
Mar. 1, 2012 (CN) 201210050940.2

(51) Int. Cl. F16B 39/00

(52) U.S. Cl. 411/103

(57) ABSTRACT

The present disclosure provides a screw with multi-hexahedron head. A head of the screw includes at least two hexahedrons which are parallel with each other. Each surface of the at least two hexahedrons is a parallelogram and parallel with the opposite face. A short height of a parallelogram bottom surface of each hexahedron is less than or equal to width of an opening of a T-shaped groove. A long height of a parallelogram bottom surface of a first hexahedron is equal to the width of the opening of the groove. A long height of a parallelogram bottom surface of a second hexahedron is greater than the width of the opening of the groove.

### BACKGROUND

1. Technical Field

The disclosure relates to screws and, more particularly, to a screw with multi-hexahedron head.

2. Description of Related Art

A head of a hex cap screw often includes six angles, and the screw cannot satisfy the size of some grooves.

Therefore, what is needed is a screw to satisfy more needs.

### BRIEF DESCRIPTION OF THE DRAWINGS

FIG. 1 is a perspective view of a screw with multi-hexahedron head in accordance with a first exemplary embodiment.

FIG. 2 is a perspective view of a screw with multi-hexahedron head in accordance with a second exemplary embodiment.

FIG. 3 is an isometric view of a bottom surface of a head of the screw of FIG. 1.

FIG. 4 is a perspective view of the screw of FIG. 1, engaged with a T-shaped groove.

FIG. 5 is a cross-sectional view of the screw of FIG. 4, engaged with the T-shaped groove

### DETAILED DESCRIPTION

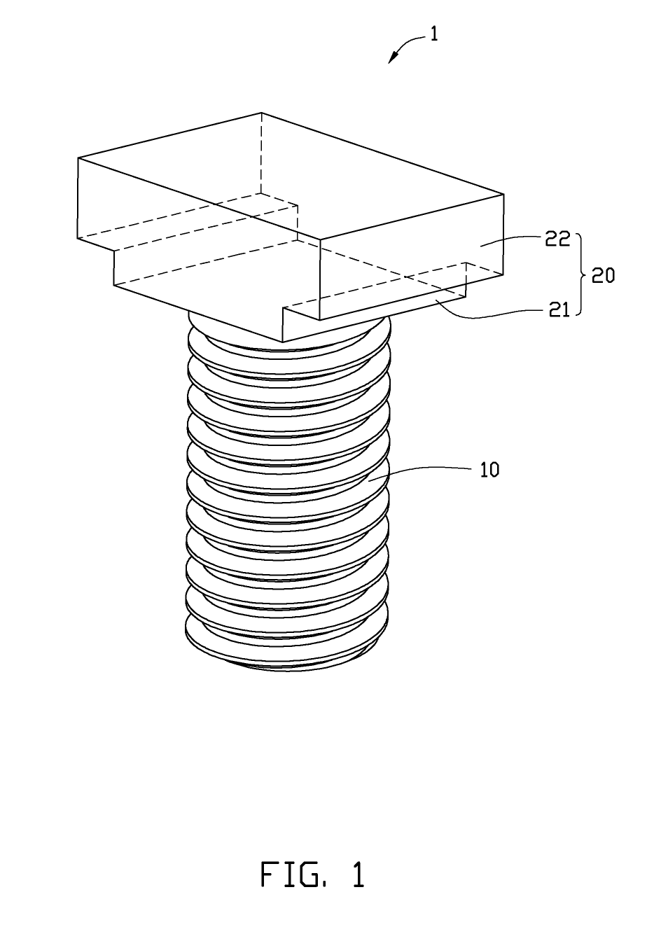

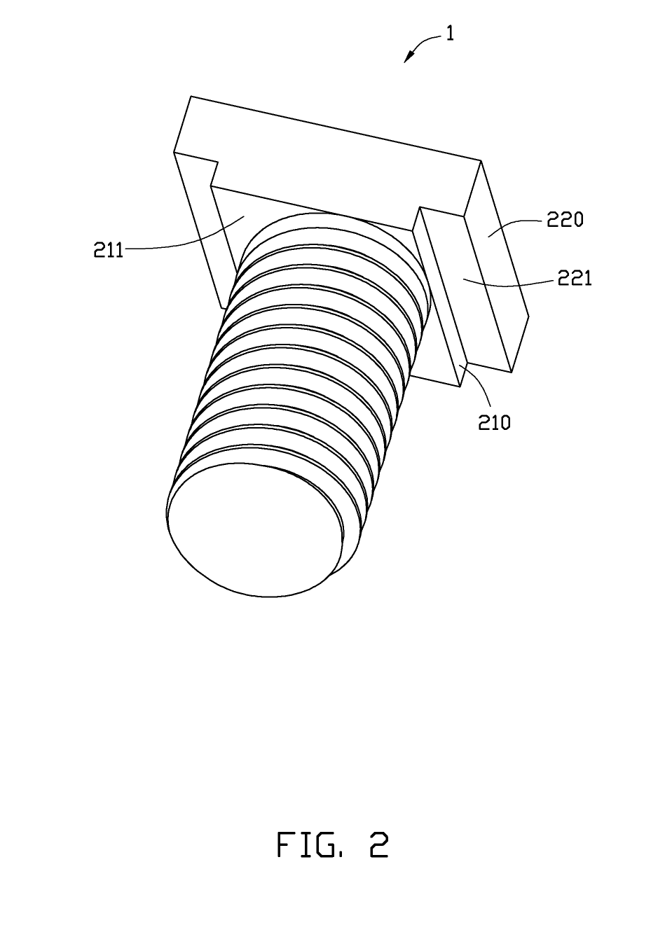

FIGS. 1-2 show a screw with multi-hexahedron head (hereinafter “the screw”). The screw 1 includes a body 10 and a head 20. The head 20 is positioned on the top of the body 10 that defines an external thread around the circumference.

The head 20 is composed of at least two hexahedrons. In the embodiment, the head 20 is composed of two hexahedrons which are a first hexahedron 21 and a second hexahedron 22. The two hexahedrons 21, 22 are parallel with each other and similar. The first hexahedron 21 defines two opposite sidewalls 210 and a first parallelogram bottom surface 211. The second hexahedron 22 defines two opposite sidewalls 220 and a second parallelogram bottom surface 221.

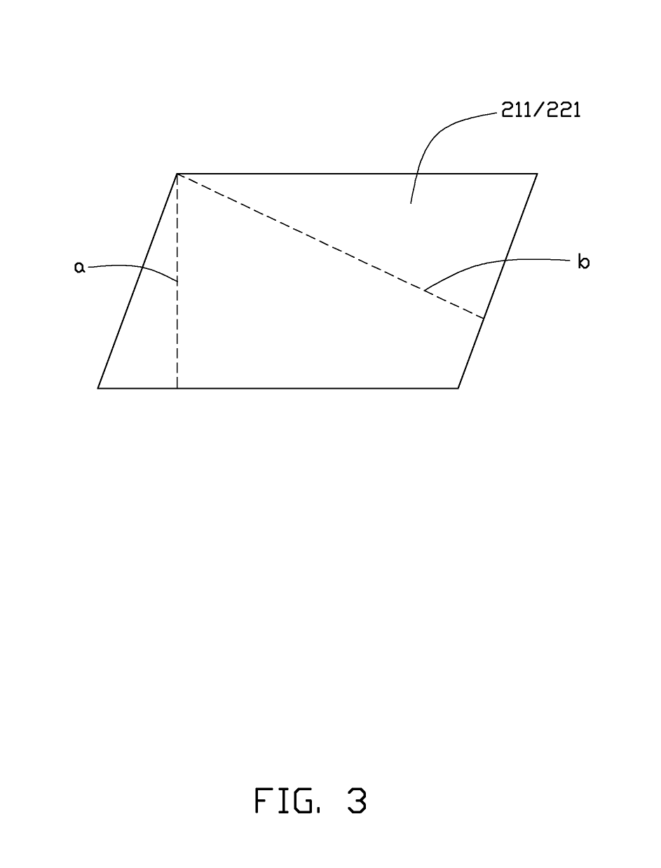

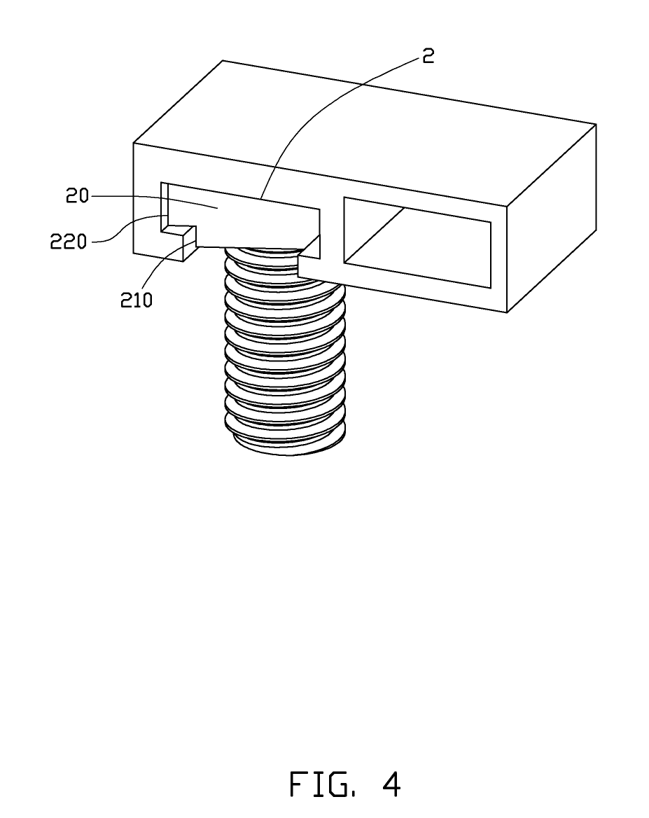

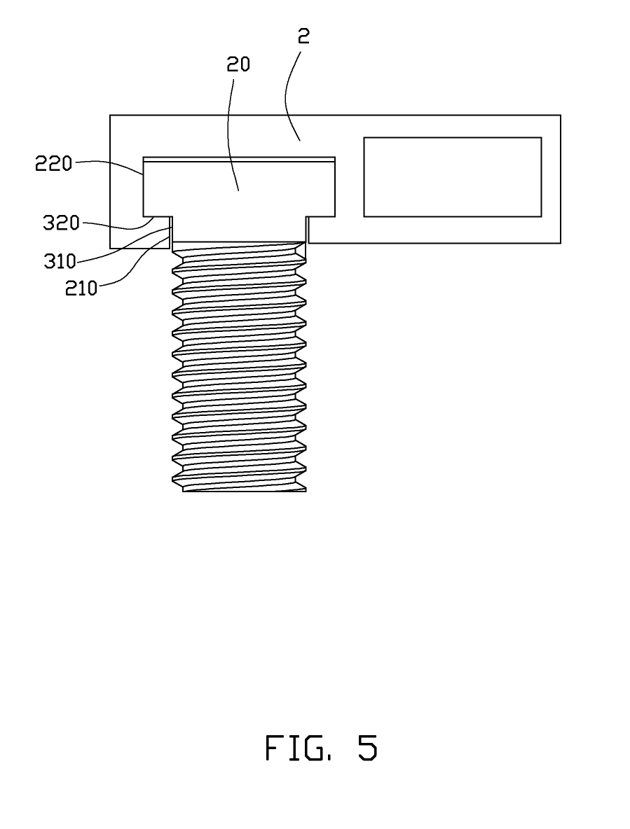

FIGS. 3-5 show the screw 1 engaged with a T-shaped groove 2. There are two heights to each of the parallelogram bottom surfaces 211, 221, a first height “a” from one side and a second height “b” from an adjacent side in FIG. 3, for example. The first height “a” is greater than the second height “b”. In the embodiment, the length of the height “a” is less than the length of the height “b”, that means that the second height “b” is greater than the first height “a”.

The second height is equal to or greater than a diameter of the body 10 and equal to or less than a width of an opening of a T-shaped groove 2. In the embodiment, the second height of the first parallelogram bottom surface 211 is equal to the second height of the second parallelogram bottom surface 221. In another embodiment, the second height of the first parallelogram bottom surface 211 is not equal to the second height of the second parallelogram bottom surface 221. Therefore, when the screw 1 is engaged with the T-shaped groove 2 via the head 20, the head 20 is directly inserted into the T-shaped groove 2 via the opening of the T-shaped groove 2.

The first height of the first parallelogram bottom surface 211 is equal to the width of the opening of the T-shaped groove 2. When the head 20 is inserted into the T-shaped groove 2 via the opening of the T-shaped groove 2, the screw 1 is rotated 90 degrees and two opposite sidewalls 210 of the first hexahedron 21 are respectively engaged with two opposite sidewalls 310 of the opening.

The first height of the second parallelogram bottom surface 221 is greater than the width of the opening of the groove 2. When the head 20 is inserted into the T-shaped groove 2 via the opening of the T-shaped groove 2, the screw 1 is rotated 90 degrees and the bottom surface 221 of the second hexahedron 22 are attached on two inner surfaces 320 of the T-shaped groove 2.

Therefore, if the ends of the T-shaped groove 2 are closed, the head 20 can be directly inserted into the T-shaped groove 2 via the opening of the T-shaped groove 2. Therefore, when the screw 1 is engaged with the T-shaped groove 2, it is stable.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A screw with multi-hexahedron head comprising:
a body; and
a head positioned on the top of the body;
wherein the head is composed of at least two hexahedrons which are parallel with each other, a parallelogram bottom surface of each of the at least two hexahedron defines a first height from one side and a second height from an adjacent side, the first height is greater than the second height, the second height is equal to or greater than a diameter of the body and equal to or less than a width of an opening of a T-shaped groove of a workpiece, and when the screw is engaged with the T-shaped groove via the head, the head is directly inserted into the T-shaped groove via the opening of the T-shaped groove.

2. The screw as recited in claim 1, wherein the head is composed of two hexahedrons, a first height from one side of a parallelogram bottom surface of a first hexahedron is equal to the width of the opening of the T-shaped groove, when the head is inserted into the T-shaped groove via the opening of the T-shaped groove, the screw is rotated 90 degrees and two opposite sidewalls of the first hexahedron are respectively engaged with two opposite sidewalls of the opening.

3. The screw as recited in claim 2, wherein the two hexahedrons are similar.

4. The screw as recited in claim 2, wherein a first height from one side of a parallelogram bottom surface of a second hexahedron is greater than the width of the opening of the groove, when the head is inserted into the T-shaped groove via the opening of the T-shaped groove, the screw is rotated 90 degrees and the parallelogram bottom surface of the second hexahedron are attached on two inner surfaces of the T-shaped groove.
